(19) United States
(12) Patent Application Publication
(10) Pub. No.: US 2004/0198904 A1
(43) Pub. Date: Oct. 7, 2004

(54) Novel heat-thickening polymers, preparation method, positive microlatex and positive latex containing same and use thereof as heat-thickening agent

(76) Inventors: Olivier Braun, Naves (FR); Paul Mallo, Croissy-Sur-Seine (FR)

Correspondence Address: Air Liquide, Intellectual Property Department, Suite 1800, 2700 Post Oak Boulevard, Houston, TX, 77056, US

(21) Appl. No.: 10/482,600

(22) PCT Filed: May 17, 2002
(86) PCT No.: PCT/FR02/01672

(30) Foreign Application Priority Data
Jun. 27, 2001 (FR) 0108487

(51) Int. Cl. C08K 3/00

(52) U.S. Cl. 524/820

(57) ABSTRACT

The invention concerns a branched or crosslinked linear polymer obtainable by polymerising N-alkyl acrylamide, wherein the alkyl radical is linear or branched and comprises 1 to 6 carbon atoms, with one or several monomers selected among the cationic monomers or monomers comprising at least a strong acid function partly salified or completely salified. The invention also concerns a method for preparing same and microlatex or positive latex containing same and their use as heat-thickening agent.

The present patent application relates to novel polymers, to their process of preparation and to their use in any type of industry. When researching the development of novel inverse latexes having a prolonged stability over time, the Applicant Company became interested in thermally-induced thickening polymers. Such copolymers have the property of developing their ability to thicken a liquid medium only from a given temperature subsequently referred to as T₀.

By definition, a polymer will be said to be a thermally-induced thickening polymer when, at atmospheric pressure, T₀ is greater than ambient temperature, that is to say greater than or equal to approximately 25° C.

Thus, at ambient temperature, the solutions comprising this polymer remain fluid and can be easily handled; it is easy to incorporate them in the medium to be thickened and then to bring about thickening by increasing the temperature of the medium.

PEO-PPO-PEO triblock polymers are thermally-induced thickening polymers belonging to the state of the art. However, these polymers develop their thermally-induced thickening property only at a concentration in the medium of the order of 15% to 20% by weight of the solution to be thickened. The copolymers based on N-isopropylacrylamide described in the French patent application published under the number 2 788 008 are also thermally-induced thickening polymers belonging to the state of the art. However, these products are difficult to obtain as it is necessary to employ a process which cannot be operated safely at the industrial level and which is potentially damaging to the environment. Furthermore, this synthetic process is complex; it comprises several successive chemical reactions which lead to the polymer with a low overall yield.

This is why the Applicant Company has endeavored to develop novel thermally-induced thickening polymers which can be easily synthesized industrially.

According to a first aspect of the present invention, a subject matter of the invention is a linear or branched polymer, characterized in that it is capable of being obtained by polymerization of N-alkylacrylamide with one or more monomers chosen from cationic monomers or monomers comprising at least one partially salified or completely salified strong acid functional group or monomers comprising at least one partially salified or completely salified weak acid functional group.

The alkyl radical substituting the acrylamide is linear or branched and comprises from one to six carbon atoms. According to a specific aspect of the present invention, the alkyl radical substituting the acrylamide is branched and is more particularly the isopropyl radical.

The term “branched polymer” denotes a nonlinear polymer which has pendant chains, so as to obtain, when it is dissolved in water, a high state of entanglement resulting in very high viscosities at a low gradient.

The strong acid functional group of the monomer comprising it is in particular the partially salified or completely salified sulfonic acid functional group or phosphonic acid functional group. Said monomer is, for example, partially salified or completely salified styrenesulfonic acid or partially salified or completely salified 2-methyl-2-[(1-oxo-2-propenyl)-amino]-1-propanesulfonic acid.

The cationic monomer is chosen in particular from quaternary ammonium derivatives. Examples of cationic monomers are the 2,N,N,N-tetramethyl-2-[(1-oxo-2-propenyl)amino]propanammonium, 2,N,N-trimethyl-2-[(1-oxo-2-propenyl)amino]propanammonium, N,N,N-tri-methyl-3-[(1-oxo-2-propenyl)amino]propanammonium or N,N,N-trimethyl-2-[(1-oxo-2-propenyl)oxy]ethanammonium salts.

The term “salified” denotes, for the strong or weak acid functional groups, the alkali metal salts, such as the sodium salt or the potassium salt, or the nitrogenous base salts, such as, for example, the ammonium salt or the monoethanolamine salt (HO—CH₂—CH₂—NH₃⁺)

A more particular subject matter of the invention is a polymer as defined above, characterized in that from 90% to 98% of the monomer units which it comprises result from the N-alkylacrylamide monomer and in that 2% to 10% of the monomer units which it comprises result from the cationic monomer or from the monomer possessing a strong acid functional group.

A very particular subject matter of the invention is a polymer as defined above, characterized in that approximately 95% of the monomer units which it comprises result from the N-alkylacrylamide monomer and in that approximately 5% of the monomer units which it comprises result from the cationic monomer or from the monomer possessing a strong acid functional group.

A particular subject-matter of the invention is a polymer as defined above capable of being obtained by polymerization of an N-alkylacrylamide with one or more monomers possessing a 1-oxo-2-propenyl radical and more particularly a polymer capable of being obtained by polymerization of N-isopropylacrylamide with one or more monomers chosen from 2,N,N,N-tetramethyl-2-[(1-oxo-2-propenyl)amino]propanammonium halides, 2,N,N-trimethyl-2-[(1-oxo-2-propenyl)amino]propanammonium halides, N,N,N-trimethyl-3-[(1-oxo-2-propenyl)amino]-propanammonium halides or N,N,N-trimethyl-2-[(1-oxo-2-propenyl)oxy]ethanammonium halides, or partially or completely salified 2-methyl-2-[(1-oxo-2-propenyl)-amino]-1-propanesulfonic acid.

Examples of such polymers are those capable of being obtained by copolymerization of N-isopropyl-acrylamide with sodium 2-methyl-2-[(1-oxo-2-propenyl)-amino]-1-propanesulfonate acid and/or with N,N,N-trimethyl-2-[(1-oxo-2-propenyl)oxy]ethanammonium chloride or those capable of being obtained by terpolymerization of N-isopropylacrylamide with a monomer chosen from sodium 2-methyl-2-[(1-oxo-2-propenyl)amino]-1-propanesulfonate acid and a monomer chosen from 2,N,N,N-tetramethyl-2-[(1-oxo-2-propenyl)-amino]propanammonium chloride, 2,N,N-trimethyl-2-[(1-oxo-2-propenyl)amino]propanammonium chloride, N,N,N-trimethyl-3-[(1-oxo-2-propenyl)amino]propanammonium chloride or N,N,N-trimethyl-2-[(1-oxo-2-propenyl)oxy]-ethanammonium chloride.

According to a second aspect of the present invention, a subject matter of the invention is a process for the preparation of the polymer or of an inverse microemulsion of the polymer as defined above, characterized in that:

a)—an aqueous solution comprising the monomers and the optional additives is emulsified in an oil phase in the presence of one or more surface-active agents, so as to form an inverse microemulsion,

b)—the polymerization reaction is initiated and then said reaction is allowed to take place in order to form an inverse microlatex, and then, optionally,

c)—said polymer is isolated.

The surface-active agent or the mixture of surface-active agents employed to prepare the inverse microemulsion generally has an HLB number of greater than or equal to 9. The amount used is between approximately 10% by weight and approximately 20% by weight of the microemulsion.

According to a third aspect of the present invention, a subject matter of the invention is a process for the preparation of the polymer or of an inverse emulsion of the polymer as defined above, characterized in that:

a)—an aqueous solution comprising the monomers and the optional additives is emulsified in an oil phase in the presence of one or more surface-active agents of water-in-oil type, so as to form an inverse emulsion,

b)—the polymerization reaction is initiated and then said reaction is allowed to take place,

c)—one or more surface-active agents of oil-in-water type is/are introduced in order to form an inverse latex, and then, optionally,

d)—said polymer is isolated.

The surface-active agent or the mixture of surface-active agents employed to prepare the inverse emulsion generally has an HLB number of between 4 and 7. The amount used is between approximately 0.5% by weight and approximately 5% by weight of the emulsion.

A more particular subject matter of the invention is a process as described above in which the mixture of surfactants employed comprises a mixture of at least one emulsifying agent of the water-in-oil type with at least one emulsifying agent of the oil-in-water type. The total amount of surfactant is between 5% and 10% by weight of the inverse latex.

The term “emulsifying agent of the water-in-oil type” denotes emulsifying agents having an HLB value which is sufficiently low to provide water-in-oil emulsions, such as sorbitan esters, for example sorbitan monooleate, sold by Seppic under the name Montane™ 80, sorbitan isostearate, sold by Seppic under the name Montane™ 70, or sorbitan sesquioleate, sold by Seppic under the name of Montane™ 83, or block copolymers of Hyperme™ B246 type, sold by Unichema.

The term “emulsifying agent of the oil-in-water type” denotes emulsifying agents having an HLB value which is sufficiently high to provide oil-in-water emulsions, such as ethoxylated sorbitan esters, for example sorbitan oleate ethoxylated with 20 mol of ethylene oxide, sold by Seppic under the name of Montanox™ 80, decaethoxylated oleyl/cetyl alcohol, sold by Seppic under the name of Simulsol™ OC 710, ethoxylated nonylphenol comprising 10 mol of ethylene oxide (10 EO), such as that sold under the name of Synperonic™ NP-10, or polyethoxylated sorbitan hexaoleates, sold by Atlas Chemical Industries under the names G-1086 and G-1096.

Use will advantageously be made, to prepare the polymers which are a subject matter of the present invention by the microemulsion polymerization technique, of a mixture of sorbitan sesquioleate and of ethoxylated sorbitan hexaoleate comprising 50 mol of ethylene oxide.

The oil phase of the microemulsion or of the emulsion is composed either of a commercial mineral oil comprising saturated hydrocarbons, such as paraffins, isoparaffins or cycloparaffins, which exhibits, at ambient temperature, a relative density of between 0.7 and 0.9 and a boiling point of greater than 180° C., such as, for example, Isopar™ M, Exxsolm D 100 S or Marcol™ 52, sold by Exxon Chemical, isohexadecane or isododecane, or of a mixture of several of these oils.

The aqueous phase employed in stage a) of the processes described above can comprise up to 50% of its weight of monomer.

The inverse microlatex obtained on conclusion of stage b) or the inverse latex obtained on conclusion of stage c) of the respective processes described above comprises between approximately 20% and 50% by weight of water.

The processes as described above can be carried out batchwise, semicontinuously or continuously.

According to another aspect of the present invention, a subject matter of the invention is an inverse microlatex capable of being obtained by the implementation of stages a) and b) of the process as described above.

According to another aspect of the present invention, a subject matter of the invention is an inverse latex capable of being obtained by the implementation of stages a), b) and c) of the process as described above.

According to another aspect of the present invention, a subject matter of the invention is the use of a polymer as defined above as thickener and more particularly the use of an inverse microlatex of said polymer or of an inverse latex of said polymer as thickener.

According to another aspect of the present invention, a subject matter of the invention is a process for thickening a liquid medium, characterized in that an effective amount of a polymer as defined above and more particularly an effective amount of the inverse microlatex of said polymer as defined above or of an inverse latex of said polymer as defined above is incorporated.

The term “effective amount” is understood to mean, in the context of the present invention, a percentage of the total weight of the thickened liquid medium generally of less than or equal to 15% by weight of polymer and preferably of less than or equal to 10% by weight of polymer.

Such compositions can be for cosmetic, pharmaceutical or industrial use and constitute a final. aspect of the present invention.

The composition can also be, and this constitutes a final aspect of the present invention, a heat-sensitive medium for the electrokinetic separation of entities, such as proteins, DNAs or RNAs, analogous to those disclosed and claimed in the French patent application published under the number 2 788 008, characterized in that it comprises an electrolyte in which an effective amount of one or more thermally-induced thickening polymers as defined above is dissolved.

The following examples illustrate the invention without, however, limiting it.

I) Preparation of the Monomers

1)—N-Isopropylacrylamide (NIPAM)

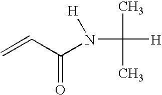

NIPAM is a commercial product.

2)—2-Acrylamido-2-methylpropylsulfonic acid

This is a commercial product sold in France by Lubrizol or CIM Chemicals. It is used subsequently in the form of a 55% by weight aqueous solution of its sodium salt, prepared by addition of powdered acid to an aqueous sodium hydroxide solution cooled in a beaker.

3)—2-Acryloxyethanetrimethylammonium chloride (AOETAC)

AOETAC is a commercial product sold in France by Atofina under the name ADAMQUAT™ MC80.

II) Preparation of the Microemulsions

1)—The Oil

Isopar™ M, sold in France by Exxon, is used.

2)—The Surfactants

The addition of a suitable amount of surfactants makes it possible to change from the emulsion to the microemulsion, which is reflected by the production of a completely transparent system. The surfactants are characterized by their HLB. The HLB concept is based on experimental methods related to the observation of the stability of an emulsion and assigns values from 1 to 20 to surfactants. This number is a measurement of the emulsifying capability and reflects the hydrophilic-lipophilic balance. It has been shown that the use of a mixture of emulsifier, one with a high HLB and the other with a low HLB, results in the formation of more stable emulsions than that obtained with a single surfactant with an equivalent HLB. This is because the two emulsifiers can form a stable complex via intermolecular associations. Several surfactants were tested:

| Commercial name | HLB | Description |
|---|---|---|
| Montane ™ 83 VG | 3.7 | sorbitan sesquioleate |
| G 1086 | 10.2 | polyethoxylated sorbitan hexaoleate |
| G 1096 | 11.4 | polyethoxylated sorbitan hexaoleate |
| Montanox ™ 80 | 15 | polyethoxylated sorbitan monooleate |
| Oramide ™ ML 802 | 5.4 | monoethanolamine oleamide |
| Oramide ™ML 835 | 9 | polyethoxylated monoethanolamine |
| | | oleamide |
| Simulsol ™ OC 72 | 4.9 | diethoxylated oleyl/cetyl alcohol |
| Simulsol ™ OC 710 | 12.4 | decaethoxylated oleyl/cetyl alcohol |

3)—Procedure for the Formulation

The change from the emulsion to the microemulsion is carried out by addition of surfactants to the aqueous phase/oil mixture. After addition of the oil, a mixture of surfactants of known HLB is then added with stirring until the system becomes transparent.

### EXAMPLE 1

### Preparation of an Inverse Microlatex of NIPAM/AMPSNa (95/5) Copolymer

A microlatex of NIPAM/AMPSNa (95/5) copolymer is prepared by carrying out the process set out above. The overall HLB number and the content of surfactants which are optimum for forming a clear microemulsion were determined. The optimum HLB is equal to 9.4 and the amounts of surfactants are indicated below with those of the other ingredients.

An aqueous solution comprising 26.3 g of sodium salt of 2-acrylamido-2-methylpropanesulfonic acid (at 55% in water), 135.2 g of NIPAM and 486.7 g of water is prepared. 684.5 g of filtered Isopar™ M are subsequently added this aqueous phase and the medium is made up with a mixture of 73.9 g of sorbitan sesquioleate and of 210.8 g of ethoxylated sorbitan hexaoleate comprising 50 mol of ethylene oxide. The mixture thus prepared is then stirred to form a microemulsion, into which nitrogen is sparged at 20° C. for one hour, and then the polymerization is initiated by addition of the sodium metabisulfite/cumene hydroperoxide oxidation/reduction couple, each at a concentration of 250 ppm per mole of monomers.

The viscometric measurements are carried out using a Haake RS 10™ rheometer provided with cone/plate geometry, so that the solution studied is under newtonian conditions (measurements of the viscosity extrapolated to zero rate gradient). Under these conditions and at 20° C., an aqueous solution comprising 8% by weight of polymer achieves a viscosity of 53 Pa.s which slowly decreases up to 39° C., from which temperature thickening begins. The viscosity then rises up to 1200 Pa.s at 60° C.

### EXAMPLE 2

### Preparation of an Inverse Latex of NIPAM/AMPSNa (95/5) Copolymer

An inverse latex of NIPAM/AMPSNa (95/5) copolymer is prepared by carrying out the process of example 1 of the international application published under the number WO 99/36445 with the following proportions of compounds:

Filtered Isopar™ M: 240 g

Sorbitan oleate: 22 g

Ethoxylated nonylphenol comprising 10 mol of ethylene oxide (10 EO): 20 g

Water: 560 g

55% by weight commercial AMPSNa solution: 26.3 g (0.063 mol)

Twice recrystallized NIPAM: 135.2 g (1.2 mol)

Sodium metabisulfite/cumene hydroperoxide couple: each 250 ppm per mole of monomers.

The viscometric measurements are carried out using a Haake RS 10™ rheometer provided with cone/plate geometry and a thermally-induced thickening effect is again observed from T₀=39° C.

### EXAMPLE 3

### Preparation of a NIPAM/AOETAC (95/5) Copolymer Latex

A microlatex of NIPAM/AOETAC (95/5) copolymer is prepared by carrying out example 1 of the international application published under the number WO 99/36445 with the following proportions of compounds:

Filtered Isopar™ M: 240 g

Sorbitan oleate: 22 g

Ethoxylated nonylphenol comprising 10 mol of ethylene oxide (10 EO): 20 g

Water: 570 g

ADAMQUAT™ MC 80: 14.5 g (0.063 mol)

Twice recrystallized NIPAM: 135.5 g (1.2 mol) Sodium metabisulfite/cumene hydroperoxide couple: each 250 ppm per mole of monomers.

The viscometric measurements are carried out using a Haake RS 10™ rheometer provided with cone/plate geometry and a thermally-induced thickening effect is again observed from T₀=40° C.

1-18. (canceled)

19. A linear or branched polymer composition comprising:
a) N-alkylacrylamide; and
b) at least one monomer.

20. The composition according to claim 19, wherein said monomer comprises at least one component selected from the group consisting of:
a) cationic monomers;
b) strong acidic functional monomers; and
c) weak acidic functional monomers.

21. The composition according to claim 20, wherein said strong acid or said weak acid functional monomer is partially or completely salified.

22. The composition according to claim 19, wherein said acrylamide is an alkyl radical.

23. The composition according to claim 22, wherein said radical is branched.

24. The composition according to claim 23, wherein said radical is an isopropyl radical.

25. The composition according to claim 19, wherein said monomer is a 1-oxo-2-propenyl radical.

26. The composition according to claim 20, wherein said cationic monomer is at least one quaternary ammonium derivative.

27. The composition according to claim 20, wherein said cationic monomer is at least one component selected from the group consisting of:
a) 2,N,N,N-tetramethyl-2-[(1-oxo-2-propenyl)amino]propanammonium;
b) 2,N,N-trimethyl-2-[(1-oxo-2-propenyl)amino]propanammonium;
c) N,N,N-trimethyl-3-[(1-oxo-2-propenyl)amino]propanammonium; and
d) N,N,N-trimethyl-2-[(1-oxo-2-propenyl)oxy]ethanammonium salt.

28. The composition according to claim 21, wherein said strong acid functional monomer is at least one component selected from the group consisting of:
a) a sulfonic acid functional monomer;
b) a phosphonic acid functional monomer; and
c) a styrenesulfonic monomer.

29. The composition according to claim 28, wherein said sulfonic acid functional monomer is a 2-methyl-2-[(1-oxo-2-propenyl)amino]-1-propanesulfonic monomer.

30. The composition according to claim 19, wherein said composition comprises:
a) a range of about 90% to about 98% of said N-alkylacrylamide; and
b) a range of about 2% to about 10% of said monomer.

31. The composition according to claim 19, wherein said composition comprises the polymerization of an N-isopropylacrylamide and at least one monomer, wherein said monomer is at least one component selected from the group consisting of:
a) 2,N,N,N-tetramethyl-2-[(1-oxo-2-propenyl)amino]propanammonium halides;
b) 2,N,N-trimethyl-2-[(1-oxo-2-propenyl)amino]propanammonium halides;
c) N,N,N-trimethyl-3-[(1-oxo-2-propenyl)amino]propanammonium halides;
d) N,N,N-trimethyl-2-[(1-oxo-2-propenyl)oxy]ethanammonium halides; and
e) partially or completely salified 2-methyl-2-[(1-oxo-2-propenyl)amino]-1-propanesulfonic acid.

32. The composition according to claim 19, wherein said composition comprises the polymerization of an N-isopropylacrylamide and at least one component selected from the group consisting of:
a) sodium 2-methyl-2-[(1-oxo-2-propenyl)amino]-1-propanesulfonate acid; and
b) N,N,N-trimethyl-2-[(1-oxo-2-propenyl)oxylethanammonium chloride.

33. The composition according to claim 19, wherein said composition comprises the terpolymerization of an N-isopropylacrylamide with sodium 2-methyl-2-[(1-oxo-2-propenylyamino]-1-propanesulfonate acid and a monomer, wherein said monomer is at least one component selected from the group consisting of:
a) 2,N,N,N-tetramethyl-2-[(1-oxo-2-propenyl)amino]propanammonium chloride;
b) 2,N,N-trimethyl-2-[(1-oxo-2-propenyl)amino]propanammonium chloride;
c) N,N,N-trimethyl-3-[(1-oxo-2-propenyl)amino]propanammonium chloride; and
d) N,N,N-trimethyl-2-[(1-oxo-2-propenyl)oxy]ethanammonium chloride.

34. A process for the preparation of an inverse microemulsion of or an inverse microlatex comprising the steps of:
i) emulsifying an aqueous solution comprising monomers in an oil phase in the presence of at least one surface-active agent;
ii) forming an inverse microemulsion;
iii) initiating and maintaining a polymerization reaction; and
iv) forming an inverse microlatex.

35. The process according to claim 34, wherein said process further comprises the step of:
v) isolating the polymer.

36. The process according to claim 34, wherein said aqueous solution further comprises at least one additive.

37. The process according to claim 34, wherein the weight of said aqueous solution comprises up to about 50% of the monomer.

38. The process according to claim 34, wherein said surface-active agent has an HLB number equal to or greater than about 9.

39. The process according to claim 34, wherein the weight of said surface-active agent is about 10%.

40. The process according to claim 34, wherein the weight of said microemulsion is about 20%.

41. The process according to claim 34, wherein the weight of said water is in the range of about 20% to about 50%.

42. The process according to claim 35, wherein said polymer or said inverse microlatex of said polymer or an inverse latex of said polymer is utilized as a thickener.

43. A process for the preparation of an inverse emulsion or an inverse latex comprising the steps of;
i) emulsifying an aqueous solution comprising at least one monomer in an oil phase in the presence of at least one surface-active agent of water-in-oil type;
ii) forming an inverse emulsion;
iii) initiating and maintaining a polymerization reaction;
iv) introducing at least one surface-active agent consisting of an oil-in-water type; and
v) forming an inverse latex.

44. The process according to claim 43, wherein said process further comprises the step of:
iv) isolating the polymer.

45. The process according to claim 43, wherein said aqueous solution further comprises at least one additive.

46. The process according to claim 43, wherein said surface-active agent has an HLB in the range of about 4 to about 7.

47. The process according to claim 43, wherein the weight of said surface active agent is about 0.5%.

48. The process according to claim 43, wherein the weight of said emulsion is about 5%.

49. The process according to claim 43, wherein the weight of said water is in the range of about 20% to about 50%.

50. The process according to claim 44, wherein said polymer, said inverse microlatex of said polymer, or an inverse latex of said polymer is utilized as a thickener.

51. The process according to claim 44, wherein said polymer is utilized in the cosmetic, pharmaceutical or industrial fields.

52. The process according to claim 44, wherein said polymer is utilized as a thickener.

53. The process according to claim 52, wherein said polymer is utilized as a thickener for a liquid medium.

54. The process according to claim 51, wherein said polymer is utilized as a heat-sensitive medium for the electrokinetic separation of entities.
